(19) United States
(12) Patent Application Publication
(10) Pub. No.: US 2006/0074763 A1
(43) Pub. Date: Apr. 6, 2006

(54) Culinary display kiosk

(76) Inventor: Matthew Schmid, Spring Lake, NJ (US)

Correspondence Address: THE MARTINEZ GROUP PLLC, Suite 1-D, 55 Poplar Street, Brooklyn Heights, NY, 11201-6930, US

(21) Appl. No.: 10/950,902

(22) Filed: Sep. 27, 2004

(51) Int. Cl. G06Q 30/00

(52) U.S. Cl. 705/26

(57) ABSTRACT

A display kiosk which provides a recipe and generates a listing of ingredients along with the location of the ingredients. The kiosk able to print out the recipe along with related coupons as well as the cost of the ingredients in the recipe, as well as being enabled to transfer the recipe to a cart having a touch screen display and an infrared port where the kiosk enables the cart to locate the ingredients of the recipe. The ingredients locatable by an RF tag and a scanner on the touch screen.

### FIELD OF THE INVENTION

The invention relates to the field of providing for a display kiosk in a market having edible goods for finding recipe items of a recipe provided by the display kiosk. The kiosk providing a general menu where the ingredients of a recipe which have been input by a shopper can be located within the market via a shopping cart which communicates with the display kiosk so as to locate the recipe items by means of an RF locator on the cart.

### BACKGROUND OF THE INVENTION

Traditional means of shopping for ingredients to a recipe requires that the shopper ascertain what recipe ingredients are located within their home and then manually prepare a list of shopping items not in their possession so as to be purchased in the market. The shopper must first find a recipe that they want to have for their meal from a recipe book and then formulate a list of ingredients with the amount needed and then purchase the items in the market. The problem with traditional means for shopping for a recipe is that the shopper has to constantly make comprehensive shopping lists every time a shopping trip is necessitated even for the same recipe at a later date. Another problem is that shoppers who purchase food items and later wish to create specific recipes after find that their selections are incomplete for the specific recipe. Also, if one shops for items of a recipe without a shopping list and relies strictly on their memory, it is often difficult to remember all the items that need to be purchased and which potentially can lead the shopper to forget items if the list is too long. This problem is further compounded if the shopper has items at their home and increases the potential of buying redundant items for their recipe. Furthermore, if the shopper desires to adhere to a financial budget, it is difficult to know how much money is being spent on the recipe items prior to visiting the market; therefore the shopper cannot change their recipe once they have arrived at the market if they are not willing to spend more than a predetermined amount on such recipe or if they have not bought enough funds with them to pay for the purchases. Additionally, with the multitude of coupons for discounted items in a market, the user is usually not informed of such coupons until the items are to be paid for which slows down the check-out time when paying for such items. Lastly, traditional means for shopping for a recipe requires that the shopper pass through each aisle in the market in search for recipe ingredients and place such ingredients in a shopping cart. The problem with such searching is that the shopper must locate each recipe item among a plurality of different products which are not related to the recipe, all the while pushing the shopping cart through each aisle in search for each item and potentially encountering blocked aisles due to restocking inventory by salespeople or high traffic due to other shoppers, all without a set method in which to search for such items efficiently. This problem is enhanced if the shopper is not familiar with the market. Currently, it is not convenient or possible with traditional shopping methods of easily obtaining a listing of items needed for a recipe, where the items can be readily located for a person not having familiarity with the market, along with tracking the running cost of such items as they are placed in a shopping cart.

It is an object of the present invention to provide a display kiosk in a market selling edible goods where the display kiosk provides a recipe.

It is further an object of the invention to provide a display kiosk which can communicate with a shopping cart having a display screen to provide the cart with the recipe from the kiosk.

It is further an object of the present invention to provide a display kiosk which can provide a list of items in a recipe along with applicable discount coupons as well as a total price associated with each item.

It is a further object of the present invention to provide for a kiosk which suggests possible recipe variations based on items found in the shopper's home.

It is a further object of the present invention to provide a display kiosk with a means by which ingredients available in the shoppers home can be input into the kiosk to provide the shopper with possible new recipes from which the shopper can choose from.

It is a further object of the present invention to provide a display kiosk which can alert the shopper to advertisements for discounted items by means of a second display screen.

It is a further object of the present invention to provide a display kiosk which provides means by which items in the market can be located by means of RF tags on the items so that a shopping cart can locate such items.

It is a further object of the present invention to provide a shopping cart in communication with the display kiosk where information on the kiosk is transferable to a touch screen on the shopping cart by a bidirectional communication link on the cart and kiosk so that the cart will notify the shopper when they are located within a certain distance from the recipe items.

It is a further object of the present invention to provide the shopping cart with a locator device which scans for an RF signal located on the recipe item in the market so that the recipe item can be efficiently located within the market along with the cost and quantity of the recipe item.

It is a further object of the present invention to provide for a kiosk and shopping cart which is enabled to provide item substitutions in the event items are not available or a more inexpensive substitution to a recipe item is available.

### SUMMARY OF THE INVENTION

In accordance with the teachings of the instant invention, there is disclosed a display kiosk which provides a shopper with a listing of recipe items or ingredients when a recipe is input into the display kiosk. The kiosk comprised of a first display screen and keyboard or touch screen in which to input the desired recipe as well as a second display screen, such as an LED, LCD, CRT or plasma screen, and a bi-directional communication link.

In accordance with one aspect of the instant invention, the recipe items from the display kiosk are downloaded onto a processor having a touch screen display on a shopping cart by means of a bi-directional communication link, such as an infra red port, bluetooth or RF (radio frequency), where the kiosk provides information to the touch screen display of the cart in order to locate the recipe items. The recipe items locatable by an RF tag generating a signal, in which the touch screen display of the cart scans the aisles by means of a locator device, scanner, or receiver so that the shopper does not needlessly enter shopping aisles that do not contain the intended recipe items or to direct the shopper to specials items or goods related to the goods the shopper desires to purchase. The kiosk is also enabled to automatically access store specials or coupons which pertain to the recipe items and transfer such store specials and coupons for the recipe items with an approximate cost of each item as well as the total cost of the recipe to the cart touch screen. The display kiosk is further able to provide a manually printed listing of the recipe items and coupons if a shopper is familiar with the market. Preferably, the kiosk instructs the cart to the location of the recipe items by means of the RF tag on each recipe item and is guided by the touch screen to the appropriate market shelf where the recipe item is located. The touch screen alerts the shopper when they are near the recipe item by means of an audible tone or visual indicator on the touch screen. The shopping cart touch screen is also enabled with a screen saver which advertises related items on the shopping list as well as any sale items which include, but are not limited to, magazines, cleaning supplies, dry goods, produce, pet foods and any specialty items which are on sale. The screen saver is operatively linked to the second display screen of the kiosk.

In a further aspect of the present invention, the display kiosk can provide the shopper with a means by which specific items can be found in the market with their appropriate locations along with a listing of variations to such specific items located in the market.

In yet a further aspect of the present invention, the kiosk also enables the shopper to input items the shopper has in their possession so that such recipe items are not listed on the touch screen of the shopping cart and further providing a recipe for such recipe items, so that alternative recipes can be listed along with the intended recipe in order to provide the shopper with a variety of food options in which they can cook a meal as well as provide an economical alternative to shopping for the intended recipe.

The instant invention as disclosed also contemplates the connection of the kiosk to a wireless connection such as the internet via a web site linked to the market where the shopper can connect to the kiosk from a remote location such as their home or place of business, so that the shopper can formulate a listing of recipe items prior to entering the market. The recipe items accessible by an encrypted password when the shopper physically accesses the kiosk so as to reduce the time the shopper is in the market searching for the recipe items.

The foregoing and other features and advantages of the present invention will be apparent from the following detailed description of the invention.

### BRIEF DESCRIPTION OF THE DRAWINGS

FIG. 1 shows a display kiosk and cart in accordance with the teachings of the instant invention.

FIG. 2 is a schematic block-diagram showing the means by which the recipe items are accumulated.

### DETAILED DESCRIPTION OF THE PREFERRED EMBODIMENTS

Referring to the drawings in detail, there are illustrated therein various exemplary embodiments of the display kiosk and shopping cart made in accordance with the teachings of the instant invention. These exemplary embodiments are not to be construed as limiting.

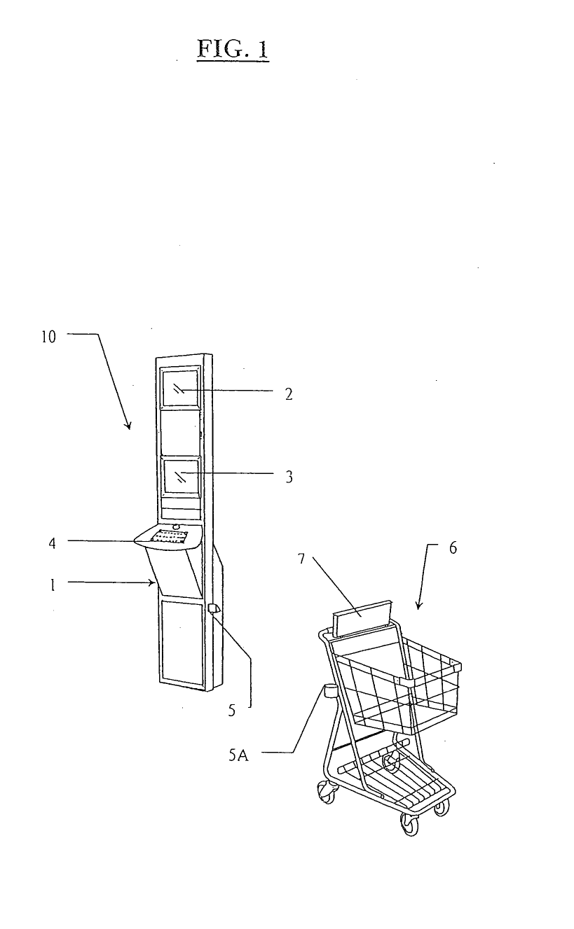

FIG. 1 shows a display kiosk 10 having a main housing 1, in which a second display screen 2 is positioned on top of the housing, the second display screen 2 displays advertised store specials as well as discounted items offered for sale and is operatively linked to a touch screen 7 of the shopping cart 6. The store specials and coupons displayed on the touch screen when the touch screen accesses a screen saver mode (not shown). The kiosk 10 comprised of a first display screen 3 and an alphanumeric keyboard 4, where the keyboard 4 is coupled to the first display 3 so that a recipe can be input by means of the keyboard 4 and subsequently, the items are listed in the display. The keyboard 4 is also used to input any items which the shopper needs, and are not associated with the recipe. The display provides a listing of items which can be edited by the shopper. When the first display 3 shows all the items required by the recipe. The cart 6 is placed in communication with the bi-directional communication link 5 on the kiosk so as to mate with a bidirectional communication link 5A on the cart 6. The touch screen 7, receives the displayed information of the kiosk so that the shopper can be directed to the listed items of the recipe. The kiosk provides a means to the touch screen to locate the recipe items using RF tags on the recipe items as well as a written means as to what aisle and shelf the item is to be located. The touch screen is enabled with a locator device or scanner which locates the appropriate RF signal from each recipe item. The cart and display providing an audible tone or visual indicator when the shopper is in close proximity to the recipe item.

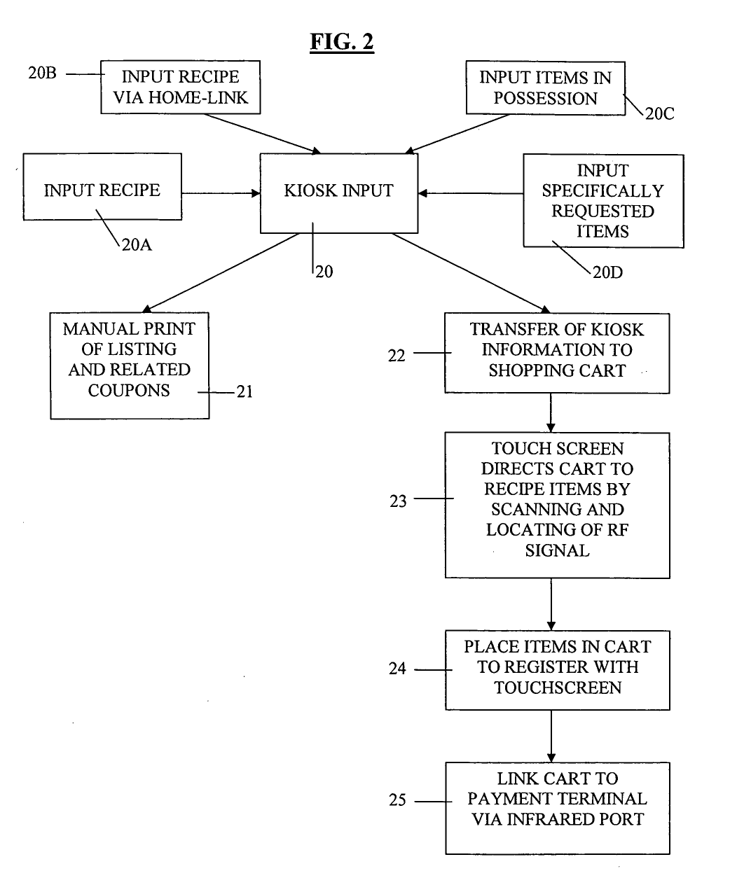

Referring to FIG. 2, a schematic block-diagram illustrates the means by which the kiosk is used to input information so as to assemble the required items from the recipe as well as any other items needed by the shopper. The kiosk 20 receives input 20A, which provides the kiosk with a recipe input by the shopper via the keyboard of the kiosk. The recipe can either be a recipe already in the kiosk via a database of well known recipes or a specific recipe can be input by the user. The kiosk is provided with a database of common and specialty recipes found in ethnic and non-ethnic cookbooks whereby the recipes can be searched by either food categories, ingredients or style of food. The databases can be provided by food companies or magazines and present an opportunity for advertising revenue from the food companies or magazines. Preferably, the kiosk is enabled to link with other databases to search for recipes not found on its internal database. An alternative means by which the shopper can input information into the kiosk is by a home-link from the shopper's home computer or smart application such as, but not limited to, a refrigerator, linked directly to the kiosk via an internet connection 20B, where an encrypted password input by the shopper into the kiosk can access the recipe imputed by the home-link as well as a shopping history if the shopper frequents the market regularly, the shopping history being accessible to the shopper upon subsequent visits. Information as to the recipe items already in the possession of the shopper are subsequently input 20C into the kiosk either by internet communication 20B or physically at the kiosk 20A via the keyboard 4, so that such items of the recipe are not listed on the kiosk display in order that the shopper does not needlessly search for such items. Lastly the user inputs items 20D that are specifically requested separately from the recipe items. Once all the inputs 20A-D are imputed into the kiosk, the kiosk via the display provides the shopper with a listing of the recipe items as well as a listing of any related items that can be substituted for items not found in the market. For example, if Beef Wellington is the recipe sought after by the shopper and the meat required is filet mignon, the user can search for another recipe or the kiosk can recommend a substitute meat having substantially similar characteristics to filet mignon. The kiosk also enabled to provide a listing of recipes for the meat substitution in order to provide the shopper with the option to choose another recipe based on the items found in the store as well as the items found in their possession 20C as previously input. The kiosk further enabled to provide a listing of related recipe items which are on sale via coupons or store specials, which can be substituted for use with the recipe. The listing of alternative recipes is for the purpose of enabling a shopper on a budget to shop economically, without obviating the ability to purchase for a specific recipe. The kiosk also enabled to remember repetitively selected recipe items so as to alert the shopper when store specials or discount coupons are available for such recipe items so that the kiosk alerts the shopper through the second display screen on the kiosk or the screen saver function on the cart touch screen. When the kiosk displays the intended recipe in its final form, and as finally edited by the shopper, the listing can be manually printed 21 for the shopper so that the shopper can locate the items in the store if the shopper is familiar with the layout of the store, or preferably, the listing can be transferred to the touch screen display 22 of the shopping cart via the bi-directional communication links 5 and 5A. Subsequently, the cart display will include all the information found on the display of the kiosk as well as any advertised specials and coupons. The shopper is then directed 23 by the cart which will locate the items required for the recipe. An audible tone or visual indicator (not shown) on the touch screen of the cart will alert the shopper if they are in close proximity to the item sought and the item will register on the display as being in the cart once the item is placed in close proximity to the touch screen 24. The recipe item being marked by means of either being highlighted, or visually “checked” on the touch screen so that the shopper does not have to account for the item any further. Once the item is in the cart, the touch screen will not scan for the item any further. Once all the items are in the cart, and the cart display alerts the user that the listing on the display is satisfied, the shopper then proceeds to a payment terminal. The cart links 25 to a payment terminal (not shown) via the bidirectional communication link 5A on the cart so that a total is listed on the payment terminal and the shopper can pay for the items in the cart. Since all of the items in the cart are RF tagged, the individual scanning of the items need not be performed since the items in the cart are accounted for as they are accumulated in the market. The shopper need only bag the items and exit the market, thus preventing payment delays.

As described above, the display kiosk and shopping cart of the instant invention provide a number of advantages, some of which have been described above and others, which are inherent in the instant invention. Modifications may be proposed to the display kiosk without departing from the teachings herein, such as enabling the kiosk with the ability to pay for purchases, thus not having to wait in line for payment of the purchases or enabling the touch screen of the cart with a credit or debit card reader so as to pay for the items without having to wait on a payment line. Accordingly, the scope of the invention is only to be limited as necessitated by the accompanying claims.

I claim:

1. A display kiosk providing a recipe, comprising:
a display kiosk having a first display screen, a second display screen, a keyboard and a bi-directional communication link wherein the display kiosk provides a listing of recipe items in a recipe imputed by a shopper so as to generate a shopping list.

2. The display kiosk as defined in claim 1, wherein a cart having a touch screen and an infrared port, the cart being in wireless communication with the display kiosk via the bi-directional communication link, and the touch screen is provided with a locator device wherein the touch screen scans for RF signals from the recipe items.

3. The display kiosk as defined in claim 1, wherein the second display screen displays discounted items.

4. The display kiosk as defined in claim 2, wherein the touch screen displays discounted items and is operatively linked to the second display screen.

5. The display kiosk as defined in claim 1, wherein the recipe is input via a home-link.

6. The display kiosk as defined in claim 5, wherein a shopper inputs recipe items in their possession into the display kiosk, wherein the display kiosk is enabled to generate alternative recipe items based on the recipe items in the shoppers possession.

7. The display kiosk as defined in claim 6, wherein the display kiosk is enabled to provide substituted recipe items.

8. The display kiosk as defined in claim 6, wherein a shopper inputs specifically requested items.

9. The display kiosk as defined in claim 1, wherein the display kiosk physically prints the generated shopping list along with respective locations and pricing of the recipe items.

10. The display kiosk as defined in claim 2, wherein the display kiosk transfers the generated shopping list to the touch screen of the cart via a bidirectional communications link.

11. The display kiosk as defined in claim 10, wherein the display kiosk provides the touch screen with directions as to the location of the recipe items via the RF signal.

12. The display kiosk as defined in claim 11, wherein the touch screen registers the recipe items when the recipe items are in close proximity to the touch screen.

13. The display kiosk as defined in claim 12, wherein the registered items are marked on the touch screen.

14. The display kiosk as defined in claim 12, wherein the touch screen communicates with a payment terminal.
